(19) United States
(12) Patent Application Publication
(10) Pub. No.: US 2014/0145097 A1
(43) Pub. Date: May 29, 2014

(54) Radiation shields and methods of making the same

(71) Applicant: Steven G. Caldwell, Hendersonville, TN (US)

(72) Inventor: Steven G. Caldwell, Hendersonville, TN (US)

(21) Appl. No.: 10/824,228

(22) Filed: Apr. 14, 2004

(51) Int. Cl. G21F 1/08

(52) U.S. Cl. CPC G21F 1/085
USPC 250/515.1

(57) ABSTRACT

Various non-limiting embodiments disclosed herein generally relate to metallurgically dense radiation shields formed from bismuth alloys comprising from 10 weight percent to 60 weight percent tin that are essentially free of toxic heavy metals chosen from lead, cadmium, and uranium; and radiation attenuation devices comprising the same. Other non-limiting embodiments disclosed herein relate to methods of making metallurgically dense radiation shields comprising bismuth alloys comprising from 10 weight percent to 60 weight percent tin. Still other non-limiting embodiments herein generally relate to methods of shielding radiation-emitting devices using metallurgically dense radiation shields formed from bismuth alloys comprising from 10 weight percent to 60 weight percent tin that are essentially free of toxic heavy metals chosen from lead, cadmium, and uranium.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A SEQUENCE LISTING

Not applicable.

### BACKGROUND

Various non-limiting embodiments disclosed herein generally relate to metallurgically dense radiation shields formed from bismuth alloys that are essentially free of toxic heavy metals and methods of making the same. Other non-limiting embodiments generally relate to methods of shielding radiation-emitting devices using metallurgically dense radiation shields formed from bismuth alloys that are essentially free of toxic heavy metals.

In order to maximize attenuation of high-energy photonic radiation through the various dissipative mechanisms involved for a given incident photon energy, radiation shielding materials should possess as high an atomic number and gravimetric density as possible. As used herein, the term “attenuation” means the process by which radiation loses energy as it travels through matter and interacts with it. As used herein the term “high-energy photonic radiation” means electromagnetic radiation having energy of at least 100 keV, and includes, for example and without limitation, x-rays and gamma rays. For example, lead and uranium, which both have high atomic numbers (82 and 92, respectively) and high gravimetric densities (11.34 grams per cubic centimeter “g/cc” and 19.05 g/cc, respectively), are very effective as radiation shielding materials.

While the toxicity, cost, and restricted availability of uranium limit the utility of this material in most radiation shielding applications, lead, by virtue of its abundance, ease of reduction from ore, low cost, ease of melting and casting, ductility, and ability to strongly attenuate many common forms of penetrating radiation, has generally been the radiation shielding material of choice. Today, lead-based radiation shields—whether in the form of shot, bricks, sheet, cast shapes, or particulate filled polymers or elastomers—dominate the radiation shielding market.

However, despite its economy, ready availability, and ease of fabrication, lead-based radiation shields have several disadvantages, foremost being toxicity. Because lead is highly toxic to both humans and the environment, during all stages of the processing, use, and disposal of lead, numerous occupational safety and environmental procedures must be followed. For example, during the fabrication and handling of lead-based radiation shields, it is often necessary to monitor airborne lead and use personal protective equipment. Further, disposal of lead-based radiation shielding and equipment containing such shielding after its useful life presents various on-going environmental concerns.

Additionally, since lead is very soft and ductile, it easily deforms so as to relieve applied stress, even at room temperature. Thus, it is difficult to securely attach lead components to other devices by mechanical means. In order to reduce this creep behavior, lead is routinely alloyed with antimony (and sometimes additionally tin), which serves as a solid solution strengthener, to produce “hard lead.” Much of the lead currently used for radiation shielding applications contains at least some alloying addition of antimony (and may also include tin) for this purpose. However, the addition of alloying elements to lead decreases the ability of the resultant lead alloy to absorb penetrating radiation such as x-rays and gamma rays as compared to pure lead. That is, because the atomic number and gravimetric density of both antimony and tin are lower than that of lead, alloying lead with such materials decreases the attenuation properties of the alloy as compared to pure lead.

Bismuth is a low toxicity metal that, like lead, possesses a high atomic number. However, because bismuth has a lower density than lead (i.e., 9.78 g/cc vs. 11.34 g/cc), the linear absorption coefficient of pure bismuth is lower than that of pure lead. More specifically, pure bismuth has a linear absorption coefficient for 100 keV photonic radiation of 56.2 cm⁻¹, whereas pure lead has a linear absorption coefficient for 100 keV photonic radiation of 63.0 cm⁻¹. As discussed below in more detail, the linear absorption coefficient depends on the photon energy, as well as the chemical composition and physical density of the shielding material. Nevertheless, bismuth has useful attenuation properties for many common forms of high-energy photonic radiation, such as and without limitation, x-rays and gamma rays.

However, while the attenuation properties of pure bismuth make it an attractive candidate for various radiation shielding applications, the mechanical properties of pure bismuth make its use in such applications generally impractical. First, because bismuth has rhombohedral crystal structure, it has a limited number of slip systems and is consequently limited in the ways in which it can plastically deform under applied stress. Therefore, pure bismuth is intrinsically brittle and difficult to work. Second, because pure bismuth possesses a very low thermal conductivity, during solidification from a melt (such as during casting), bismuth cools very slowly, forming very large grains (i.e., faceted growth) and correspondingly large area grain boundaries. Large area grains boundaries can further contribute to the poor forming characteristics of bismuth as they can serve as paths for easy crack initiation and propagation in the brittle matrix. Accordingly, because pure bismuth has a tendency to crack and fracture during shaping and/or handling, it is generally impractical to make metallurgically dense radiation shields from pure bismuth.

As used herein, the term “metallurgically dense” with respect to a radiation shield means that the radiation shield is formed from a metal or metal alloy having a density of at least 98 percent of the theoretical density of the metal or metal alloy. Further, the term “metallurgically dense radiation shield” specifically excludes radiation shields formed from polymers and elastomers filed with metal or metal alloy powders. Further, as used herein, the term “theoretical density of the metal” means the true density of the metal when fully densified into a product with no pores.

Consequently, while pure bismuth has been-utilized in radiation shielding applications, for example, U.S. Pat. No. 5,028,789, at col. 5, lines 3-18, discloses a layer of a gamma ray-attenuating material, which preferably comprises a bismuth filter comprised of one or more substantially pure bismuth crystals, other radiation shielding applications utilize pure bismuth as a coating applied to another substrate. For example, the abstract of U.S. Pat. No. 5,334,847 discloses a radiation shield having a depleted uranium core for absorbing gamma rays and a cast bismuth coating for preventing chemical corrosion and absorbing gamma rays. Further, the abstract of U.S. Pat. No. 5,604,784 discloses mixing granulated bismuth with a liquid carrier and applying the mixture to a surface to provide radiation attenuation.

Additionally, radiation shields formed from polymers and/or elastomers filled with pure bismuth and bismuth alloys powder are known. For example, at col. 3, lines 20-25, U.S. Pat. No. 5,360,666 discloses radiation shields formed from mixtures of spherical particle powders, including bismuth-tin powders, in a polymerizable elastomeric precursor or resin. U.S. Pat. No. 5,247,182 at col. 6, line 57 through col. 7, line 20 discloses an energy attenuation material comprised of a layer of a polymer including 7-30% by weight of a thermoplastic polymer, 0-15% by weight of a plasticizer, and 70-93% by weight of an inorganic composition consisting essentially of at least two elements or compounds selected from, among others, bismuth and tin.

Further, bismuth alloys with lead and tin, and bismuth alloys with lead, tin and cadmium (also known as “Lipowitz alloys”) have been used as radiation shielding materials that can be easily melted with minimal heating and cast to shape—often near the point of use. For example, radiology labs have employed Lipowitz alloys for many years to make special and/or complex geometry radiation shields for use in radiological fixture applications. As used herein, the term “radiological fixture” means a clinical positioning device for various parts of a patient's body that provide both radiation shielding and immobilization of the given body part. Table I shows the compositions of two commonly used Lipowitz alloys.

TABLE I

| Element | Alloy 158* | Alloy 203 |
|---|---|---|
| bismuth | 50 | 50 |
| lead | 26.7 | 32.0 |
| tin | 13.3 | 15.5 |
| cadmium | 10.0 | 0 |

*Commercially available as “Cerrobend” alloy from Cerro Metal Products of Bellefonte, PA.

However, as evident from Table I, both compositions contain either lead or lead and cadmium and therefore can pose the same toxicity concerns as the above-described lead-based radiation shielding.

### BRIEF SUMMARY

Various non-limiting embodiments disclosed herein are directed toward metallurgically dense radiation shields and devices comprising the same. For example, one non-limiting embodiment provides a metallurgically dense radiation shield comprising a bismuth alloy comprising from 10 weight percent to 60 weight percent tin and being essentially free of lead, cadmium, and uranium.

Another non-limiting embodiment provides a metallurgically dense radiation shield comprising a solidified, binary bismuth-tin alloy comprising from 35 to 45 weight percent tin and a lamellar microstructure, the metallurgically dense radiation shield having a thickness of less than 0.1 inches.

Another non-limiting embodiment provides a radiation shield comprising at least one metallurgically dense layer of a bismuth alloy comprising from 10 weight percent to 60 weight percent tin and being essentially free of lead, cadmium, and uranium.

Another non-limiting embodiment provides a device for attenuating radiation comprising at least one metallurgically dense radiation shield comprising a bismuth alloy comprising from 10 weight percent to 60 weight percent tin and being essentially free of lead, cadmium, and uranium.

Still another non-limiting embodiment provides an apparatus comprising a radiation-emitting source and a device for attenuating radiation positioned proximate at least a portion of the radiation-emitting source such that an amount of radiation emitted from the source is attenuated by the device, the device comprising at least one metallurgically dense radiation shield comprising a bismuth alloy comprising from 10 weight percent to 60 weight percent tin and being essentially free of lead, cadmium, and uranium.

Other non-limiting embodiments disclosed herein contemplate methods of making radiation shields. For example, one non-limiting embodiment provides a method of making a metallurgically dense radiation shield comprising a bismuth alloy comprising from 10 weight percent to 60 weight percent tin and being essentially free of lead, cadmium, and uranium, the method comprising forming a melt comprising bismuth and tin, and casting the melt.

Another non-limiting embodiment provides a method of making a radiation shield comprising a bismuth alloy comprising from 10 weight percent to 60 weight percent tin, the method comprising compacting a powder metal composition comprising bismuth and from 10 to 60 weight percent tin.

Still another non-limiting embodiment provides a method of forming a metallurgically dense radiation shield comprising thermal spraying at least one layer of a bismuth alloy comprising from 10 weight percent to 60 weight percent tin onto a substrate.

Yet another non-limiting embodiment provides a method of forming a metallurgically dense radiation shield comprising thermal spraying at least one layer of a bismuth alloy comprising from 10 weight percent to 60 weight percent tin into a mold to form the metallurgically dense radiation shield and removing the metallurgically dense radiation shield from the mold.

Other non-limiting embodiments disclosed herein are directed toward methods of shielding radiation-emitting sources. For example, one non-limiting embodiment provides a method of shielding a radiation-emitting source comprising positioning a metallurgically dense radiation shield proximate the radiation source such that an amount of radiation emitted from the source during use is attenuated by at least a portion of the metallurgically dense radiation shield, the metallurgically dense radiation shield comprising a bismuth alloy comprising from 10 to 60 weight percent tin and being essentially free of lead, cadmium, and uranium.

### BRIEF DESCRIPTION OF THE SEVERAL VIEWS OF THE DRAWING(S)

Various non-limiting embodiments disclosed herein will be better understood when read in conjunction with the drawings in which:

FIG. 1 is a schematic, perspective view of one non-limiting embodiment of a radiation shield having a simple geometry;

FIG. 2 is a schematic, perspective view of one non-limiting embodiment of a cylindrical isotope transport container;

FIG. 3 is a schematic, perspective view of one non-limiting embodiment of a radiation shield having a curved surface;

FIG. 4 is a schematic, perspective view of one non-limiting embodiment a radiation shield having a interlocking shape configuration; and

FIG. 5 is a Bi—Sn binary alloy phase diagram.

### DETAILED DESCRIPTION OF EMBODIMENTS OF THE INVENTION

As previously discussed, bismuth is a low toxicity metal having useful attenuation properties for many common forms of high-energy photonic radiation. However, due to its brittle nature, pure bismuth is difficult to form into suitable shapes for use in radiation shielding applications and is susceptible to cracking. Further, as discussed above, while bismuth alloys containing lead and tin, or lead, tin and cadmium have been used in radiological radiation shielding applications, because these alloys contain heavy metals such as lead and cadmium, certain safety measures must be taken when working with the materials during fabrication, maintenance, and disposal of the radiation shield.

As discussed above, various non-limiting embodiments disclosed herein generally relate to metallurgically dense radiation shields formed from bismuth alloys that are essentially free of toxic heavy metals and methods of making the same. Other non-limiting embodiments generally relate to methods of shielding radiation-emitting devices using one or more metallurgically dense radiation shield formed from bismuth-tin alloys. Non-limiting embodiments of radiation shields according to the present invention will now be described.

One non-limiting embodiment provides a metallurgically dense radiation shield comprising a bismuth alloy comprising from 10 weight percent to 60 weight percent tin and being essentially free of toxic heavy metals selected from lead, uranium, and cadmium. As used herein, the term “radiation shield” refers to a solid-state element that is adapted to attenuate radiation and has a desired shape or geometry. Further, as used herein the term “solid-state element” refers to an element that is in the solid, as opposed to liquid or molten, state. As previously discussed, the term “metallurgically dense” means that the radiation shield is formed from a metal or metal alloy having a density of at least 98 percent of the theoretical density of the metal or metal alloy.

As previously discussed, the use of heavy metals such as lead, uranium, and cadmium pose both health and environmental concerns. Thus, according to various non-limiting embodiments disclosed herein, the bismuth alloy used to form the radiation shield is essentially free of lead, uranium, and cadmium. As used herein with respect to the bismuth alloy, the term “essentially free of” means having no more than impurity amounts of the specified metals, i.e., no intentional additions of the specified metals. For example, although not limiting herein, impurity levels generally do not exceed 0.01 weight percent of the alloy.

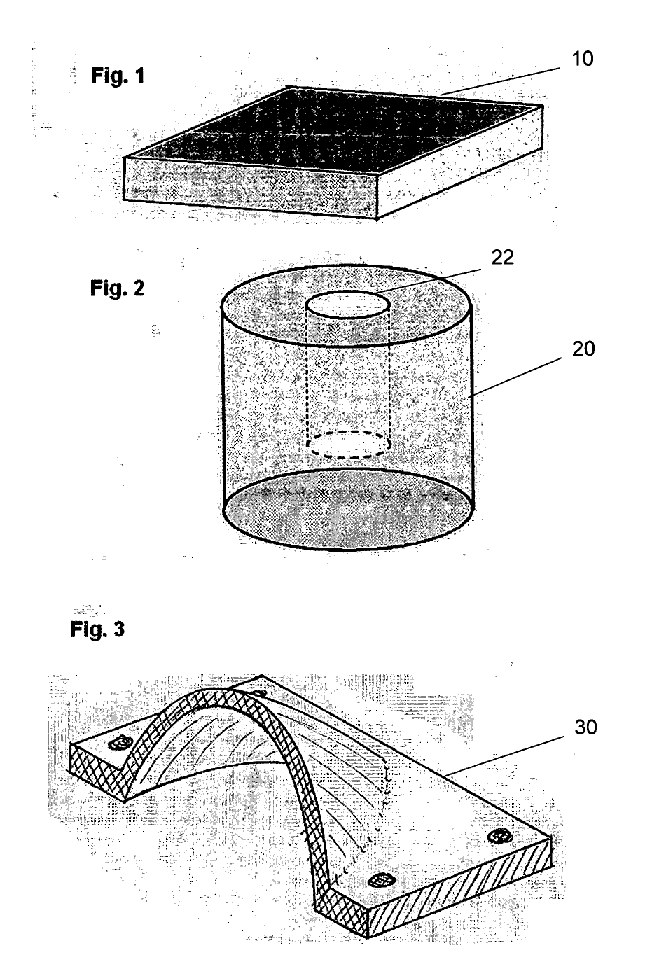

The metallurgically dense radiation shields according to various non-limiting embodiments disclosed herein can have any shape or geometry required or desirable for a given application. Although not limiting herein, in one non-limiting embodiment, the metallurgically dense radiation shield has a basic shape such as a block, a plate, or a cylinder. For example, as shown in FIG. 1, in one non-limiting embodiment the metallurgically dense radiation shield 10 can have the shape of a plate. In another non-limiting embodiment, as shown in FIG. 2, the metallurgically dense radiation shield 20 can have the shape of a cylinder. Further, the radiation shield can be a solid shape, as shown in FIG. 1, or, as shown in FIG. 2, it can have one or more recesses or apertures formed therein. Although not limiting herein, for example, as shown in FIG. 2, the metallurgically dense radiation shield 20 can have an aperture 22 for confining a radiation-emitting isotope or other vessel containing a radiation-emitting isotope therein. Such a configuration can be useful, for example, in forming an isotope transport container.

In another non-limiting embodiment, the metallurgically dense radiation shield can have a complex geometric shape. As discussed above, radiological fixtures can have a complex geometry in order to conform to a body part or some portion thereof. One non-limiting example of metallurgically dense radiation shield have a complex geometric shape is shown in FIG. 3. Although not limiting herein, for example, radiation shield 30 can be used as a radiological fixture for shielding a portion of a patient's head during radiation therapy or as a space-efficient, contoured cover for an x-ray source.

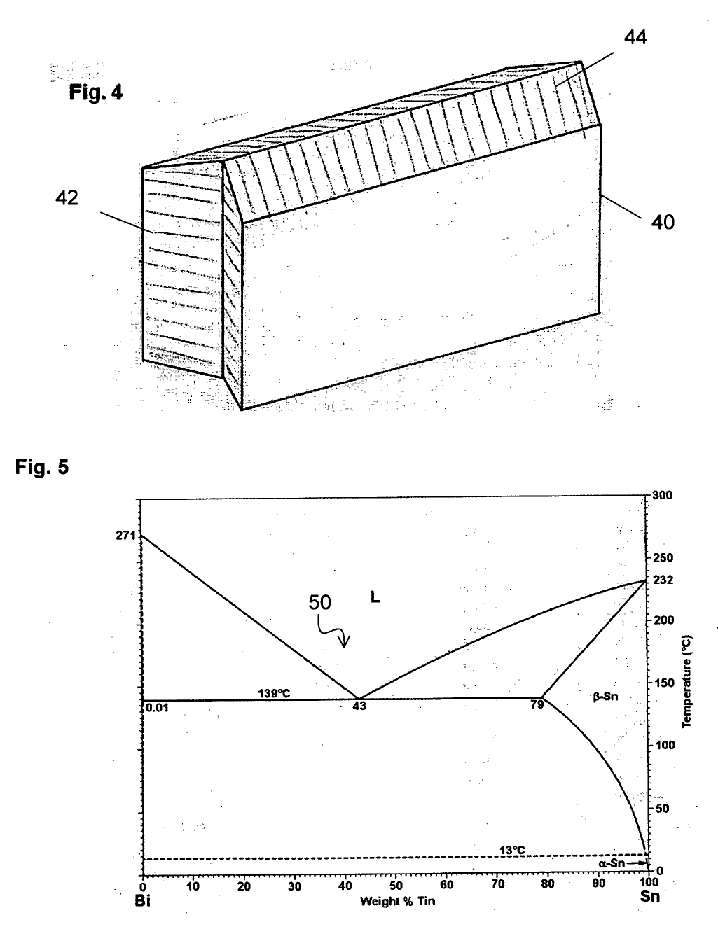

In another non-limiting embodiment, the metallurgically dense radiation shield can have an interlocking shape. As used herein, the term “interlocking shape” with respect to the radiation shield means that, when the radiation shield is placed adjacent an element with a complementary geometry (e.g., another radiation shield), the radiation shield will engage the element in more than one plane. Such an arrangement, for example, may be useful to prevent or reduce straight-line leakage of photonic radiation through the radiation shield. Although not limiting herein, one example of a metallurgically dense radiation shield having an interlocking shape is shown in FIG. 4. As shown in FIG. 4, the metallurgically dense radiation shield 40 can have an interlocking shape having mating or engagement surfaces 42, 44 that are adapted to engage other elements with complementary geometries when placed adjacent thereto. As shown in FIG. 4, the engagement surfaces 42, 44 have a chevron configuration. However, other configurations for the engagement surfaces known in the art can be used in accordance with this non-limiting embodiment.

As previously discussed, forming metallurgically dense radiation shields from pure bismuth is generally impractical owing to the brittle nature of pure bismuth. However, although not meant to be limiting herein, the inventor has discovered that by appropriately alloying bismuth with tin, metallurgically dense radiation shields having good attenuation properties, reduced brittleness, and low toxicity can be formed.

Generally speaking, the amount of tin present in the bismuth alloy according to various non-limiting embodiments can be any amount required to provide an alloy having the required forming characteristics, such as ductility and melting point, and the necessary or desired attenuation properties. As discussed below in more detail, according to one non-limiting embodiment the metallurgically dense radiation shield can comprise a bismuth alloy comprising from 10 weight percent to 35 weight percent tin. According to another non-limiting embodiment, the metallurgically dense radiation shield can comprise a bismuth alloy comprising from 35 weight percent to 45 weight percent tin. According to still another non-limiting embodiment, the metallurgically dense radiation shield can comprise a bismuth alloy comprising from 45 weight percent to 60 weight percent tin.

Although not limiting herein, according to one non-limiting embodiment wherein the radiation shield to be formed has a large, relatively simple shape, for example a block, a plate, a brick, or a cylinder shape, the amount of tin employed can be the minimum amount needed to impart adequate ductility to the alloy system. For example and without limitation, according to this non-limiting embodiment, the bismuth alloy can comprise from 10 weight percent to 35 weight percent tin, and can more specifically comprise from 10 weight percent to 25 weight percent tin. Further, according to one non-limiting embodiment, the bismuth alloy can be a hypoeutectic, binary bismuth-tin alloy. Although the use of bismuth alloys comprising from 10 to 35 weight percent tin is discussed above with respect to radiation shields having relatively simple shapes, nevertheless, it is contemplated that radiation shields having complex geometries or interlocking shapes can be formed from such alloys as well.

Another non-limiting embodiment provides metallurgically dense radiation shield having a geometry that requires that the bismuth alloy be shaped or formed, for example by plastically deforming the alloy. According to this non-limiting embodiment, the bismuth alloy can comprise from 45 weight percent to 60 weight percent tin. Further, according to one non-limiting embodiment, the bismuth alloy can be a hypereutectic, binary bismuth-tin alloy. Nevertheless, it is contemplated that bismuth alloys comprising from 45 to 60 weight percent tin can also be used to form radiation shields having interlocking, simple, or complex shapes.

According to still another non-limiting embodiment wherein the metallurgically dense radiation shield has a more complex shape, for example a shape that has more challenging geometric shape details and/or possesses thin wall sections, the bismuth alloy can be a eutectic or near-eutectic composition. For example, although not limiting herein, according to this non-limiting embodiment, the bismuth alloy can comprise from 35 weight percent to 45 weight percent tin. However, in other non-limiting embodiments, bismuth alloys comprising from 35 to 45 weight percent tin can be used to form a radiation shield that requires shaping or forming and/or has a simple or an interlocking shape. For example, although not limiting herein, in one non-limiting embodiment the metallurgically dense radiation shield comprises a bismuth alloy comprising approximately 40 weight percent tin and has an interlocking shape.

As shown in FIG. 5, the bismuth-tin binary alloy system has a relatively deep eutectic, generally indicated as 50. That is, melting at the eutectic composition occurs at a temperature well below that of either pure bismuth or pure tin. For example, as shown FIG. 5, elemental bismuth and tin melt at 271° C. and 232° C. respectively; however, the melting point of the eutectic composition (which is located at 57 weight percent bismuth and 43 weight percent tin) is only 139° C., permitting easy melting and casting of the eutectic composition with only modest equipment requirements. This low melting point can facilitate point-of-use casting of customer radiation shields (i.e., custom shapes) and can reduce the working temperatures for any subsequent metallurgical shaping operations as well. Thus, according to certain non-limiting embodiments wherein a low melting point alloy is desired, the metallurgically dense radiation shield can comprise a eutectic or near-eutectic bismuth-tin binary alloy comprising from 35 to 45 weight percent tin.

Attenuation of incident penetrating radiation for a radiation shield is given by the following equation I:

Iₜ/Iᵣ=exp(−μx) Eq. I

wherein, Iᵣ is the incident radiation intensity; Iₜ is the intensity of transmitted radiation, i.e., the intensity of radiation transmitted through the radiation shield; x is the thickness of the radiation shield; and μ is the linear absorption coefficient of the shielding material, i.e., the material from which the radiation shield is formed. Radiation shield thickness is most commonly expressed in centimeters (cm) and the linear absorption coefficient is expressed in units of cm⁻¹. The linear absorption coefficient of a shielding material is an indication of the degree to which an X-ray or gamma-ray photon will interact with the shielding material it is traversing per unit path length traveled. As previously discussed, the linear absorption coefficient depends on the photon energy, as well as the chemical composition and physical density of the shielding material.

The linear absorption coefficient (μ) of the shielding material can be obtained by multiplying the mass coefficient of absorption of the shielding material (μₘ), which is commonly expressed in units of cm²/g, by the density (ρ) of the shielding material as shown in the following equation II:

μ=μₘ*ρ Eq. II

Mass coefficients of absorption (μₘ), can be determined either empirically or by numerical simulation through the use of routines, such as the XCOM:Photon Cross Sections Database program which is available from the National Institute of Standards and Technology (“NIST”) (and on-line at http://physics.nist.gov/PhysRefData/Xcom/Text/XCOM.html). For alloys and composite materials, the mass coefficient of absorption is a weighted sum of the mass attenuation coefficients of the various components of the composite material, with the weighting factor being the weight fraction of the particular component.

The linear absorption coefficients for several non-limiting examples of bismuth alloys that can be useful in forming the metallurgically dense radiation shields according to various non-limiting embodiments disclosed herein are given below in Table II.

TABLE II

| | | |
|---|---|---|
| | | Linear Absorption |
| Alloy | Density | Coefficient (cm⁻¹) |

| Composition | (g/cc) | at 100 keV | at 6 MeV |
|---|---|---|---|
| Bi—10Sn | 9.48 | 50.5 | 0.41 |
| Bi—35Sn | 8.72 | 37.7 | 0.36 |
| Bi—43Sn | 8.54 | 34.1 | 0.35 |
| Bi—45Sn | 8.49 | 33.2 | 0.34 |
| Bi—60Sn | 8.12 | 26.8 | 0.32 |

As illustrated in Table II, for photon energies representative of those commonly used for both diagnostic imaging applications (approximately 100 keV) and oncology applications (approximately 6 MeV), as the amount of tin in the alloy increases, the linear absorption coefficients for the alloy decreases. Thus, as previously discussed, according to various non-limiting embodiments disclosed herein, the tin content of the alloy can be selected for a given application so as to achieve a desired balance of alloy properties, such as ductility and radiation absorption capability. For example, although not limiting herein, according to certain non-limiting embodiments disclosed herein, wherein relatively high attenuation properties are desired, the amount of tin in the alloy is maintained as low as possible to achieve the required deformation characteristics of the alloy so as to maximize the linear absorption coefficient of the bismuth alloy, and hence, the radiation shield.

Another non-limiting embodiment provides a metallurgically dense radiation shield comprising a bismuth alloy having a eutectic composition. On solidification, a lamellar microstructure of alternating layers (or lamellae) of essentially pure bismuth and bismuth-tin solid-solution, respectively, is formed during cooling at essentially all practical cooling rates. Due to the compositional uniformity of the fine lamellar microstructure, the radiographic density of the material is also very uniform, making the eutectic composition suitable for radiation shielding applications wherein point-to-point uniformity in absorption of the shield is more critical. For example, a radiation shield having the eutectic lamellar microstructure described above can be desirable for use in shielding applications requiring the use of a radiation shield having a relatively thin cross-section. In such applications, due to the thin cross-section of the radiation shield, the effect of any microstructural inhomogeneities in the shielding material may not be suitably averaged out in certain ray paths through the radiation shield. Accordingly, the point-to-point uniformity in absorption afforded by the lamellar microstructure described above can be particularly beneficial in such applications. Although not limiting herein, in one non-limiting embodiment, the metallurgically dense radiation shield comprises a binary bismuth-tin alloy comprising from 35 to 45 weight percent tin and a lamellar microstructure and has a thickness of less than 0.1 inches.

Another non-limiting embodiment provides a radiation shield comprising at least one metallurgically dense layer of a bismuth alloy comprising from 10 weight percent to 60 weight percent tin and being essentially free of lead, cadmium, and uranium. Further, according to this non-limiting embodiment, the radiation shield can comprise a plurality of metallurgically dense layers of a bismuth alloy comprising from 10 weight percent to 60 weight percent tin and being essentially free of lead, cadmium, and uranium. As used herein, the term “metallurgically dense layer of a bismuth alloy” means that the layer has a density of at least 98 percent of the theoretical density of the bismuth alloy from which it is formed.

Embodiments of the present invention further contemplate devices for attenuating radiation. For example, one non-limiting embodiment provides a device for attenuating radiation comprising at least one, and desirably a plurality, of metallurgically dense radiation shields comprising a bismuth alloy comprising from 10 weight percent to 60 weight percent tin and being essentially free of lead, cadmium, and uranium. For example, the device for attenuating radiation can comprise a stack or other modular arrangement of such radiation shields.

Still other embodiments of the present invention contemplate apparatus incorporating radiation shields and devices for attenuating radiation as discussed above. For example, one non-limiting embodiment provides an apparatus comprising a radiation-emitting source and a device for attenuating radiation positioned proximate at least a portion of the radiation-emitting source such that an amount of radiation emitted from the source is attenuated by the device. Further, according to this non-limiting embodiment, the device for attenuating radiation can comprise at least one metallurgically dense radiation shield comprising a bismuth alloy comprising from 10 weight percent to 60 weight percent tin and being essentially free of lead, cadmium, and uranium. Non-limiting examples of apparatus according this non-limiting embodiment include imaging apparatus, radiotherapy apparatus, and apparatus used to decontaminate items such as food or mail.

Further, according this non-limiting embodiment, the radiation-emitting source of the apparatus can be photonic radiation-emitting source. For example, although not limiting herein, depending upon the application, the radiation-emitting source can be chosen from x-ray emitting sources and gamma-ray emitting isotopic sources. Non-limiting examples of gamma-ray emitting isotopic sources include: cesium-137, cobalt-60, iridium-141, technicium-99m, and radioisotopes that decay with positron emissions giving rise to 511 keV photonic radiation.

Additionally, although not limiting herein, according to certain embodiments wherein the apparatus is an imaging apparatus, radiation emitted from the radiation-emitting source can have photon energies of at least 100 keV. In other non-limiting embodiments, wherein the apparatus is a radiotherapy apparatus, the radiation emitted from the radiation-emitting source can have photon energies of at least 6 MeV.

As previously discussed, the apparatus according to various non-limiting embodiments disclosed herein can comprise at least one metallurgically dense radiation shield comprising a bismuth alloy comprising from 10 weight percent to 60 weight percent tin and being essentially free of lead, cadmium, and uranium. Further, as discussed above, the amount of tin used to form the radiation shield will depend upon factors such as the deformation characteristics and attenuation properties of the resultant alloy. Thus, according to one non-limiting embodiment, the apparatus can comprise at least one metallurgically dense radiation shield comprising a bismuth alloy comprising from 10 weight percent to 35 weight percent tin. In another non-limiting embodiment, the at least one metallurgically dense radiation shield can comprise a bismuth alloy comprising from 35 weight percent to 45 weight percent tin. In still another non-limiting embodiment, the at least one metallurgically dense radiation shield can comprise a bismuth alloy comprising from 45 weight percent to 60 weight percent tin.

Methods of making radiation shields according to various non-limiting embodiments of the present invention will now be described. One non-limiting embodiment provides a method of making a metallurgically dense radiation shield comprising a bismuth alloy comprising from 10 weight percent to 60 weight percent tin and being essentially free of lead, cadmium, and uranium, the method comprising forming a melt comprising bismuth and tin, and casting the melt.

Non-limiting methods of forming melts of bismuth and tin include melting a bismuth alloy that has been pre-alloyed with the desired amount of tin, melting pure bismuth and pure tin together in the desired proportions, and combinations thereof. When pre-alloyed bismuth is used, as previously discussed, the temperature required to melt the bismuth alloy will depend largely upon the amount of tin present in the alloy. For example, although not limiting herein, when the bismuth alloy has the eutectic composition, melting the bismuth alloy can comprise heating the bismuth alloy at temperature of near, at, or above 139° C.

Methods of melting bismuth and tin include those methods conventionally known in the art for melting metals. For example, although not limiting herein, bismuth and tin (and/or pre-alloyed bismuth-tin alloy) can be placed into a crucible or other container and heated in a furnace to melt the metals. Although not necessary, if required, the melt can be agitated to induce mixing and homogenization of the melt. Further, the furnace used can be any suitable furnace including, but not limited to, electric furnaces, induction furnaces, and gas furnaces.

As previously discussed, according to one non-limiting embodiment, after forming the melt comprising bismuth and tin, the melt is cast. Methods of casting that can be used in conjunction with this non-limiting embodiment include those methods commonly known for casting metals.

According to various non-limiting embodiments disclosed herein, after the bismuth alloy is cast, no further processing is required. According to other non-limiting embodiments disclosed herein, after casting, the cast bismuth alloy can be further processed, for example and without limitation, by at least one of machining, deformation processing, or heat treating.

As previously discussed, the amount of tin present in the alloy will affect both the processing and attenuation properties of the alloy formed therefrom. For example, although not limiting herein, in one non-limiting embodiment, wherein the bismuth alloy will undergo little plastic deformation after casting, the bismuth alloy can comprise 10 weight percent to 35 weight percent tin. In another non-limiting embodiment, wherein the melting temperature of the bismuth alloy is desired to be relatively low, the bismuth alloy can comprise from 35 weight percent to 45 weight percent tin. In still another non-limiting embodiment, wherein the bismuth alloy will undergo plastic deformation after casting, the bismuth alloy can comprise from 45 weight percent to 60 weight percent tin.

Another non-limiting embodiment provides a method of making a radiation shield comprising forming a green part from a powder metal composition comprising bismuth and from 10 weight percent to 60 weight percent tin and, optionally, at least partially sintering the green part. As used herein the term “green part” means an unsintered part formed from metal powders. Although non-limiting herein, in addition to metal powders, the green parts according to various non-limiting embodiments disclosed herein may include other non-metal constituents such as, but not limited to, binders, carriers, lubricants, and surfactants.

According to this non-limiting embodiment, the powder metal composition can comprise elemental bismuth powders, elemental tin powders, pre-alloyed bismuth-tin powders, or any combination thereof to achieve an overall bismuth alloy composition comprising from 10 weight percent to 60 weight percent tin. Further, according to various non-limiting embodiments disclosed herein, the powder metal composition can be essentially free of lead, cadmium, and uranium.

As discussed above, the amount of tin present will depend upon factors such as the desired deformation characteristics and attenuation properties of the resultant bismuth alloy. Therefore, in one non-limiting embodiment, the powder metal composition can comprise from 10 weight percent to 35 weight percent tin. In another non-limiting embodiment, the powder metal composition can comprise from 35 weight percent to 45 weight percent tin. In still another non-limiting embodiment, the powder metal composition can comprise from 45 weight percent to 60 weight percent tin. Further, as discussed above, the powder metal compositions according to various non-limiting embodiments disclosed herein can further comprise processing aids, which can facilitate the formation of the green parts. Non-limiting examples of such processing aids include binders, lubricants, carriers and surfactants.

Methods of forming green parts from powder metal compositions that are suitable for use in conjunction with various non-limiting embodiments disclosed herein include those methods well known in the art. For example, in one non-limiting embodiment, the green part can be formed by compacting the powder composition. As used herein, the term “compacting” means compressing powders together to form a green part from the pressure-induced mechanical bonding of metal particles. Non-limiting examples of powder compaction techniques include unaxial compression, biaxial compression, and isostatic pressing. Further, if desired, the powders can be heated during compaction.

As discussed above, according to certain non-limiting embodiments, after forming the green part, the green part is optionally at least partially sintered. As used herein the term “sinter” or “sintering” means exposing a green or pre-sintered part to an elevated temperature to cause interdiffusion and mass transport between adjacent metal particles. Although not limiting herein, while some sintering can be performed at a temperature below the eutectic temperature of the bismuth-tin system (i.e., 139° C.), in some non-limiting embodiments, sintering can be performed at a temperature at or above the eutectic temperature such that at least a transient liquid phase is formed. However, it will be appreciated by those skilled in the art that the exact sintering times and temperatures required will depend, in part, upon the overall composition of the alloy, as well as the types of powders employed and the shape of the compact. Further, while not limiting herein, if desired, the green part can be pre-sintered prior to sintering. As used herein, the term “pre-sintered” means heating the part to a temperature below the sintering temperature to gain strength for subsequent handling.

After sintering, if required, the sintered part can be further processed, for example and without limitation, by at least one of machining, deformation processing, or heat treating at least a portion of the bismuth alloy.

According to another non-limiting embodiment, a metallurgically dense radiation shield can be formed by compacting a powder metal composition comprising bismuth and from 10 to 60 weight percent tin without the need for sintering the compact. That is, certain compacting techniques make it possible to directly press parts with adequate density to be used to form a metallurgically dense radiation shield. For example, although not limiting herein, if the compaction pressure used in uniaxial pressing is sufficiently high, the ductile tin powders can be caused to flow with substantial elimination of porosity. Further, the pressure requirements for tin metal flow can be reduced with the application of elevated temperature during compaction, for example, by hot pressing. Additionally, according to this non-limiting embodiment, if required, the metallurgically dense radiation shield can be further processed, for example and without limitation, by at least one of machining, deformation processing, or heat treating at least a portion of the bismuth alloy after compaction.

According to another non-limiting embodiment, the metallurgically dense radiation shield can be formed by thermal spraying. As used herein the term “thermal spraying” means a process in which finely divided metallic materials are deposited in a molten or semi-molten state to form a coating, layer, or structure. For example, in one non-limiting embodiment, the metallurgically dense radiation shield can be formed by thermal spraying one or more layers of a bismuth alloy comprising from 10 weight percent to 60 weight percent tin into a mold, such as, for example, a contoured aluminum mold, having a desired configuration and subsequently removing the bismuth alloy from the mold after solidification. Alternatively, according to another non-limiting embodiment, the metallurgically dense radiation shield can be formed by thermal spraying a bismuth alloy comprising from 10 weight percent to 60 weight percent tin onto a substrate having a desired configuration to form a coating or layer over the substrate that is capable of attenuating radiation as discussed above. Non-limiting methods of thermal spraying the bismuth alloy include, electric arc spraying, flame spraying, plasma spraying, and powder flame spraying.

The present invention also contemplates methods of shielding a radiation-emitting source comprising positioning a metallurgically dense radiation shield proximate the radiation source such that an amount of radiation emitted from the source during use is attenuated by at least a portion of the metallurgically dense radiation shield, the metallurgically dense radiation shield comprising a bismuth alloy comprising from 10 weight percent to 60 weight percent tin and being essentially free of lead, cadmium, and uranium. Non-limiting examples of radiation-emitting sources are described above. Non-limiting examples of suitable metallurgically dense radiation shields are described above in detail.

Various embodiments disclosed herein will now be illustrated in the following, non-limiting, prophetic examples.

### Examples

### Example 1

A large rectangular radiation shielding block is to be constructed as a non-toxic replacement for a lead brick. In this application, it is desirable to match the protection level provided by a given thickness of lead as closely as possible. Since this is a static application involving a large material section thickness, the ductility requirements for the alloy are generally low. On the basis of these considerations, a hypoeutectic bismuth-tin alloy can be chosen so as to provide the maximum radiation absorption possible while maintaining processability of the alloy. A block shape can be cast using a bismuth-15 weight percent tin (“Bi-15Sn”) alloy. For this application, the addition of 15 weight percent tin can effectively retard the faceted growth solidification mode of pure bismuth and can provide sufficient ductility for durability of corners against handling damage, while detracting as little as possible from the linear absorption coefficient of bismuth.

### Example 2

An irradiation system requires the use of a thin, profiled radiation shield to selectively reduce the central intensity of an x-ray beam from a source so as to produce a more even intensity beam over the intended irradiation area. For such a radiation shield, an alloy at or near the eutectic composition for the bismuth-tin system can be chosen. In making this material selection, the amount of proeutectic bismuth or tin, which regions in thin sections could provide regions of higher or lower attenuation, respectively, can be minimized or eliminated. The fine, lamellar eutectic microstructure can provide consistent beam attenuation over the entire irradiation area. A central bulge can be created in the radiation shield for higher central absorption by either casting to shape or turning of a cast blank on a lathe—the latter operation being possible due to the ductility-enhancing effect of the tin addition. Casting can also be performed to high precision since dimensional changes during solidification can be minimized near the center of the phase diagram by balancing the positive and negative expansion values of tin and bismuth, respectively.

### Example 3

A complex geometry cast shape is to be fabricated to shield a specific shape of x-ray head in a volume efficient manner, while providing good attenuation of radiation in all unintended directions. Attachment holes are to be cast into the radiation shield, so as to minimize finishing operations. This can be accomplished through the use of a contour machined, reusable aluminum alloy mold containing removable pins to produce the required cast-in-place holes. For this application it is desirable to maintain as high a linear absorption coefficient as possible. Based on these considerations, a hypoeutectic alloy at or near the composition Bi-30Sn can be chosen. Such an alloy can provide a useful compromise in protection level, ductility for dependable service in moving equipment, and minimal expansion for dependable replication of the desired complex shape.

### Example 4

A cylindrical radiation shield having a relatively thick wall is to be cast for the temporary storage and transport of radioactive materials, e.g., a isotope container. A blind central hole is to be created during casting using a mandrel. Due to the likelihood of rough handling of a shipping container, a highly damage resistant material is desired for use in this application as a replacement for conventional lead material. Further, for this application, the linear absorption coefficient of the alloy need not be maximized due to the bulk nature of the shield. Therefore, a more ductile hypereutectic Bi-55Sn can be chosen, as the proeutectic tin grains provide ductility to resist the routine rough handling and vibration the component will likely experience.

It is to be understood that the present description illustrates aspects of the invention relevant to a clear understanding of the invention. Certain aspects of the invention that would be apparent to those of ordinary skill in the art and that, therefore, would not facilitate a better understanding of the invention have not been presented in order to simplify the present description. Although the present invention has been described in connection with certain embodiments, the present invention is not limited to the particular embodiments disclosed, but is intended to cover modifications that are within the spirit and scope of the invention, as defined by the appended claims.

1. A metallurgically dense radiation shield consisting essentially of:
a plate consisting of a binary bismuth-tin alloy, the bismuth-tin alloy consisting of bismuth and from 10 weight percent to 60 weight percent tin,
wherein the plate lacks pores or channels through which radiation can pass unobstructed, and
wherein the plate has a density of at least 98 percent of the theoretical density of the bismuth alloy, and further wherein the radiation shield is suitable for attenuating high-energy photonic radiation having energy greater than 100 keV.

2. (canceled)

3. The metallurgically dense radiation shield of claim 1 wherein the bismuth-tin alloy comprises a hypoeutectic, binary bismuth-tin alloy.

4. The metallurgically dense radiation shield of claim 1 wherein the bismuth-tin alloy comprises from 10 weight percent to 35 weight percent tin.

5. The metallurgically dense radiation shield of claim 1 wherein the bismuth alloy is a hypereutectic, binary bismuth-tin alloy.

6. The metallurgically dense radiation shield of claim 1 wherein the bismuth alloy comprises from 45 weight percent to 60 weight percent tin.

7. The metallurgically dense radiation shield of claim 1 wherein the bismuth alloy comprises from 35 weight percent to 45 weight percent tin.

8. A metallurgically dense radiation shield comprising a binary bismuth-tin alloy comprising from 35 to 45 weight percent tin and a lamellar microstructure, the metallurgically dense radiation shield having a thickness of less than 0.1 inches.

9. A radiation shield comprising at least one metallurgically dense layer of a bismuth alloy comprising from 10 weight percent to 60 weight percent tin and being essentially free of lead, cadmium, and uranium.

10. A device for attenuating radiation comprising:
at least one metallurgically dense radiation shield suitable for attenuating high-energy photonic radiation of greater than 100 keV, comprising:
a plate consisting of a binary bismuth-tin alloy, the bismuth-tin alloy consisting of bismuth and from 10 weight percent to 35 weight percent tin,
wherein the plate lacks pores or channels through which radiation can pass unobstructed, and
wherein the plate has a density of at least 98 percent of the theoretical density of the bismuth alloy, and further wherein the radiation shield is suitable for attenuating high-energy photonic radiation having energy greater than 100 keV.

11-48. (canceled)

49. A metallurgically dense radiation shield comprising:
a plate consisting of a binary bismuth-tin alloy, the alloy consisting of bismuth and from 10 weight percent to 60 weight percent tin;
wherein the plate has a density of at least 98 percent of the theoretical density of the bismuth alloy;
wherein the plate lacks pores or channels through which radiation can pass unobstructed; and
wherein the radiation shield is suitable for attenuating high-energy photonic radiation having energy greater than 100 keV.
